(19) United States
(12) Patent Application Publication
(10) Pub. No.: US 2022/0414341 A1
(43) Pub. Date: Dec. 29, 2022

(54) INTENT ADDITION FOR A CHATBOT

(71) Applicant: Hewlett-Packard Development Company, L.P., Spring, TX (US)

(72) Inventors: Rafael Dal Zotto, Porto Alegre (BZ); Franco Vieira E Souza, Porto Alegre (BZ)

(21) Appl. No.: 17/781,312

(22) PCT Filed: Dec. 3, 2019
(86) PCT No.: PCT/US2019/064129

§ 371 Date: May 31, 2022

(51) Int. Cl. G06F 40/35

(52) U.S. Cl. CPC G06F 40/35; G06F 40/205

(57) ABSTRACT

In some examples, a system receives, from a source associated with a first domain, a first intent for the first domain, the first intent not included in a collection of intents for which a chatbot is able to fulfill requests, the collection of intents comprising a second intent for a second domain different from the first domain. The system adds the first intent to an intent repository containing the collection of intents, the intent repository accessible by the chatbot in fulfilling requests corresponding to intents contained in the intent repository, wherein after the adding of the first intent, the intent repository comprises the first intent for the first domain and the second intent for the second domain.

### BACKGROUND

A chatbot includes a system that is able to conduct a conversation (including an exchange of voice and/or text, for example) with a human user or another entity. The chatbot can receive commands (spoken commands and/or text commands) and can perform services in response to the commands.

### BRIEF DESCRIPTION OF THE DRAWINGS

Some implementations of the present disclosure are described with respect to the following figures.

FIG. 1 is a block diagram of an example arrangement that includes an intent manager and a chatbot, in accordance with some examples.

FIG. 2 is a block diagram of an arrangement in which a chatbot interacts with a knowledge owner to add intents for the chatbot, according to further examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context indicates otherwise. Also, the term “includes,” “including,” “comprises,” “comprising,” “have,” or “having” when used in this disclosure specifies the presence of the stated elements, but do not preclude the presence or addition of other elements.

A chatbot can also be referred to as an intelligent virtual assistant or any other type of electronic agent that allows end users to interact with the chatbot using natural language (including voice and/or text) as input. The chatbot can simulate an intelligent conversational interface that enables interactive chat sessions with human users via auditory or textual techniques. A chatbot can include machine-readable instructions that perform the tasks of the chatbot, or a combination of a hardware processing circuit and the machine-readable instructions that are executable on the hardware processing circuit to perform the tasks of the chatbot.

The natural language input (including voice and/or text and/or possibly other information) of a user can be referred to as an utterance of the user. The chatbot can receive the utterance through a microphone if the utterance includes a vocal command. Alternatively, or additionally, the utterance can be received by the chatbot through another type of input device, such as a keyboard or touchscreen display if the utterance includes text.

The chatbot is trained to understand a user intention (“intent”) based on a received utterance, and based on the intent, the chatbot can perform a fulfillment action, such as generating a response to the user and/or performing a service for the user.

The chatbot includes a collection of intents, and each intent can be defined by a collection of utterances. Each utterance may have a slot, multiple slots, or zero slots. A slot may be mandatory or optional. A slot of an utterance can refer to a value that can be used to populate a variable. For example, in the utterance “I want to book a room at the ABC Hotel for next weekend.” the slots can include “a room” (a number of rooms), “ABC Hotel” (a name of the hotel), and “next weekend” (a timeframe). These slots are used to fulfill the intent “Reserve a room,” by booking, with the ABC Hotel or with an online reservation website, a room at the ABC Hotel in the requested timeframe. In the foregoing example, the act of booking a room is an example of a fulfillment action that is associated with the intent and that can be performed or triggered by the chatbot.

A fulfillment can include an action (or multiple actions) resolving the original intent. A fulfillment action can include providing an auditory or textual answer in response to a received utterance. The auditory or textual answer can be output using a speaker and/or on a display device. Another fulfillment action can include performing a service, such as searching content in a database, executing a specific task such as turning lights on or off, interacting with an entity (e.g., a program, a website, a user, a machine, etc.), and so forth.

A chatbot is trained to understand specific intents. For example, sample utterances for known intents can be provided during training of the chatbot. The chatbot can implement a machine-learning model that is updated based on sample utterances for each intent the chatbot is to be used for. Given sample utterances for a given intent, the machine-learning model of the chatbot can be use updated such that the machine-learning model can recognize the same or similar utterances and identify an intent that is a best fit for each received utterance. Once trained, the chatbot is able to understand the utterances (or other similar utterances) as corresponding to respective intents.

Table 1 below lists example intents (in the first column), along with sample utterances for respective intents in the second column. The example intents include a first intent to “Reserve a room,” and a second intent to “Check price.”

TABLE 1

| Intent | Sample Utterances | Slots | Fulfilment |
|---|---|---|---|
| Reserve a room | I want to book a room at the | Room type slot | The chatbot will extract the dates |
| | ABC Hotel for next weekend | Hotel name or location slot | and room type and hotel name or |
| | I want a family room for | Date slot | location, and update a reservation |
| | Christmas in New York | “room” is an example | database with the reservation |
| | I want two single rooms for | value of a Room type slot | |
| | the week of December 2 in | “ABC Hotel” is an | |
| | Houston | example value of a hotel | |
| | | name or location slot | |
| | | “next weekend” is an | |
| | | example value of a Date slot | |
| Check price | How much is a family | Room type slot | The chatbot will extract the dates |
| | room tomorrow at XYZ | Hotel name or location slot | and room type and hotel name or |
| | Hotel | Date slot | location, and send a cost estimate |
| | What is the daily | | to the user (no updates of the |
| | price for a single | | reservation database) |
| | room for the next | | |
| | weekend in Los Angeles | | |

The third column of Table 1 lists the fulfillment actions that can be performed by the chatbot in response to detected intents based on received utterances.

A chatbot is able to understand utterances for intents for which the chatbot has been trained. Such intents can be part of a specific number of domains (e.g., intents in a travel reservation domain, intents in a device activation domain relating to activating devices, etc.). A chatbot that is not trained on intents for a given domain will not be able to understand utterances for the given domain. If the chatbot does not understand an utterance, the chatbot may respond with an indication that the chatbot is unable to fulfill the request, such as with: “Sorry, I do not understand,” etc.

In accordance with some implementations of the present disclosure, an intent extensible system is provided to allow addition of intents for new domains that can be fulfilled by a chatbot. A “domain” can refer to a knowledge area in which the chatbot can fulfill requests. For example, the chatbot may be currently trained to fulfill requests relating to intents in a travel reservation domain (e.g., intent to book an airline ticket, an intent to book a hotel room, an intent to rent a car, etc.) and intents in a device activation domain (e.g., an intent to activate a light, an intent to open a door, an intent to activate or adjust a cooling or heating system, etc.).

The intent extensible system can allow addition of intents for a new information technology (IT) support domain (e.g., an intent to seek help for a faulty device, an intent to upgrade a program or device, an intent to add processing or storage capacity, etc.). Once the intents for the new IT support domain are added, the chatbot would be able to fulfill the intents for the new IT support domain.

As explained further below, addition of intents is accomplished by importing definitions (or more generally, representations) of intents into an intent repository. A representation of an intent can include sample utterances for the intent, slot(s) (if any) of an utterance, and a reference (e.g., a pointer) to a fulfillment for the intent. The reference to the fulfillment can include information that identifies or otherwise indicates action(s) to be performed in response to an utterance for the intent. For example, the pointer can point to a component that given the value(s) of the slot(s) of a request will be used (called) to handle the request. Details relating to intent importation are provided further below.

Using techniques according to some implementations of the present disclosure, a common chatbot infrastructure (including a chatbot and associated resources) can be used by different users or teams, and the chatbot can be extended to support intents of new domains so that the different users or teams do not have to create individual chatbots for different domains. A chatbot can be associated with a frontend resource (e.g., an interface to a user, such as in the form of a desktop application, a mobile application, a call center number, a communication platform, etc.), a backend resource (e.g., a logging resource to log received utterances), and other resources. If multiple chatbots are created for respective different domains, then the corresponding resources would also have to be provided for the multiple chatbots, which is associated with high overhead and costs of deployment due to duplication of resources. By utilizing a common chatbot infrastructure for different domains, resource deployment can be made more efficient and costs can be reduced.

Different users or teams can integrate their knowledge into the intent repository, so that the chatbot can be extended with the added knowledge without having to create new chatbots or customizing an existing chatbot.

Example Arrangement for Importing Intents

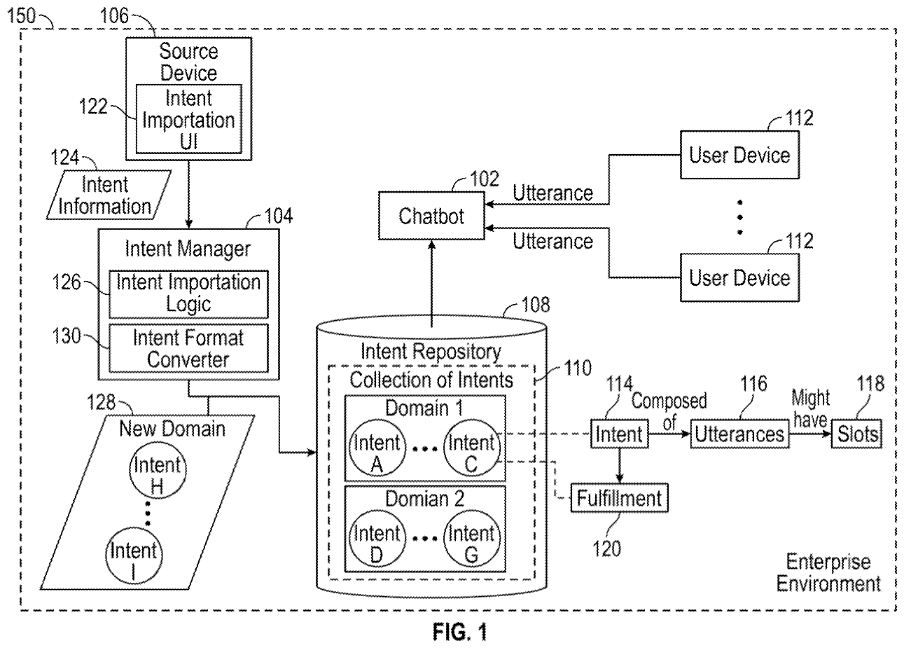

FIG. 1 is a block diagram of an example arrangement that includes a chatbot 102 and an intent extensible system according to some implementations of the present disclosure. The intent extensible system includes an intent manager 104 that is able to import, based on input from a source device 106, intents for a new domain into an intent repository 108. The intent manager 104 can be implemented as a computer (or as multiple computers) that is able to communicate over a network (wired network or wireless network) with the source device 106 and/or other devices. As specific examples, the intent manager 104 can be deployed in a cloud, in a data center, and so forth.

The intent repository 108 refers to any data structure (e.g., a database (relational database, non-relational database, graph database, etc.), a file, a table, etc.) that can store a collection of intents 110 in multiple domains. As shown in FIG. 1, the collection of intents 110 includes intent A to intent C in domain 1, and intent D to intent G for domain 2. Based on the collection of intents 110 in the intent repository 108, the chatbot 102 is able to understand utterances corresponding to intents for either domain 1 or domain 2.

Metadata can be included to identify which domains each intent in the intent repository 108 is associated with. The domain that an intent is associated may be identified by a source that added the intent, or may be inferred from the sample utterances for the intent.

In further examples, metadata of the intents can be used to determine relationships between the intents. The relationships between intents can be based on similarities of the intents. For example, a graph can be built in which nodes represent the intents, and edges between the nodes represent similarities between the intents. In other example, relationships between intents can be represented in a different manner. In some examples, the relationships between intents can be used by the chatbot when answering a request for a first intent to let the user know that the chatbot also can answer requests relating to another intent that is related to the first intent.

As further shown in FIG. 1, users can use respective user devices 112 to interact with the chatbot 102. Examples of user devices include any or some combination of the following: a desktop computer, a notebook computer, a tablet computer, a smartphone, a game appliance, a wearable device (e.g., a smart watch, a head-mounted device, smart eyeglasses, etc.), or any other type of electronic device. Each user device 112 includes an input device, such as a microphone and/or a keyboard or touchscreen, to allow the user to enter an utterance that can be provided to the chatbot 102.

As shown in FIG. 1, an intent 114 is composed of a collection of utterances 116, and each individual utterance may have a slot 118, multiple slots 118, or no slots. A slot 118 may be mandatory or optional.

The chatbot 102 processes a received utterance (which can be one of the utterances 116 or an utterance similar to the utterances 116) and attempts to identify the intent of the received utterance based on parsing the received utterance. The identified intent is one of the intents in the collection of intents 110 of the intent repository 108 for which the chatbot 102 has been trained. During the identification of the intent, the chatbot 102 also attempts to fill the slots with content in the received utterance. In some cases, the chatbot 102 may ask follow-up questions to determine values for any mandatory slot(s).

Once values for the mandatory slots are determined (note that values for optional slots do not have to be determined), the intent is ready to be fulfilled by the chatbot 102 as fulfillment 120 (e.g., booking, with the ABC Hotel or with an online reservation website, a room at the ABC Hotel in the requested timeframe). If a value is not provided for an optional slot, then the chatbot may infer the value of the optional slot from other information, such as by using location information of a user device (e.g., based on Global Positioning System (GPS) coordinates) to fill in the value for the optional slot (assuming a location slot).

The source device 106 can cause importation of intents for a domain into the intent repository 108. The source device 106 can include any of the following: a user device belonging to a person or a group of persons authorized to add intents to the intent repository 108, a server computer, or any other computer. In further examples, the source device 106 can include the chatbot 102 (or can interact with the chatbot 102), or can include another chatbot.

In some examples, the source device 106 can be associated with a trusted source (e.g., a person, a group of persons, a program, a machine, etc.) that has been designated as authorized to add intents to the intent repository 108.

The intent manager 104 can prevent (such as based on a configuration or setting of a system administrator or the owner of the chatbot) sources that are not authorized from adding intents to the intent repository 108. Sources that are not authorized may lack expertise or knowledge, and may add content to the intent repository 108 that is inaccurate or not precise. In some cases, non-authorized sources may be malicious. In some examples, a system administrator can lock down the write access of the intent repository 108 for adding knowledge to specified sources. In other examples, the intent manager 104 may allow any source to add intents to the intent repository 108.

The intent manager 104 may perform authentication and authorization of sources before allowing the sources to add content to the intent repository 108. For example, the authentication and authorization of a source may be based on a credential or other information provided by the source. In other examples, a profile can be associated with a source, where the profile can define what types of intents (or for what knowledge domains) the source can add to the intent repository 108.

In further examples, the chatbot 102 can be used in an enterprise environment 150, such as a work environment, a school environment, a government environment, or any other environment that includes a collection of users. An enterprise can refer to a business concern, an educational organization, a government agency, or any other type of organization. The enterprise environment 150 refers to an environment associated with the enterprise. For example, the enterprise environment 150 can include a network (or networks) that are internal to the enterprise, and which is protected against unauthorized access by entities outside the enterprise environment 150.

In some examples, the intent extensible system (and more specifically, the intent manager 104) can allow importation of intents into the intent repository 108 from sources within the enterprise environment 150, and can disallow importation of intents into the intent repository from outside the enterprise environment 150. The allowance or disallowance of importation of intents from sources within or outside the enterprise environment 150 may be based on configuration of a system administrator or owner of the chatbot 102, for example.

In further examples, the intent manager 104 may allow any source to add intents to the intent repository 108. However, the intent manager 104 is able to distinguish between a trusted source and a non-trusted source. The intent manager 104 may associate tags or other metadata with the intents added to the intent repository 108. For example, a first indicator (e.g., a flag, a field, an information element, etc.) may indicate that an intent in the intent repository 108 was added by a trusted source, while a second indicator different from the first indicator may indicate that an intent in the intent repository 108 was added by a non-trusted source. In such examples, when consuming an intent from the intent repository 108, the chatbot 102 may include in a response for the intent an indicator of whether or not the intent is from a trusted source or non-trusted source.

In the example of FIG. 1, it is assumed that the source device 106 is used by a person who is authorized to add intents to the intent repository 108. The source device 106 includes a display device in which an intent importation user interface (UI) 122 can be presented. The intent importation UI 122 allows the user of the source device 106 to make input entries or selections for importing intents into the intent repository 108. For example, the user can use the intent importation UI 122 to select a file (or multiple files) containing definitions of intents for importation to the intent repository 108. The user can also use the intent importation UI 122 to add information relating to the intents to be imported. Such added information is discussed further below.

The intent importation UI 122 can be presented at the source device 106 based on the interaction between the source device 106 and the intent manager 104. The intent manager 104 can include an intent importation logic 126, which can be in the form of a web service, an application program, or any other type of machine-readable instructions that can present and/or interact with the intent importation UI 122 at the source device 106. As part of importing intents into the intent repository 108, the intent importation logic 126 can validate the intents (discussed below), and may flag intents as being from trusted or non-trusted sources.

The source device 106 can send intent information 124 to the intent manager 104 in response to an input made at the intent importation UI 122 to import intent(s). In some examples, it is also possible for the intent manager 104 to seek from the source device 106 (or the user of the source device 106) further information for each new intent to be added. Such further information (metadata) can allow the intent importation logic 126 to qualify, organize, and classify each intent. Qualifying an intent can include verifying and validating the intent (discussed further below). Organizing the intent can include including storing the intent with other intents of the same domain. Classifying an intent can include determining the type of the intent, including the knowledge domain in which the intent is part of.

The intent information 124 can include a representation of an intent to be added, where the representation can include sample utterances for the intent, slot(s) (if any) of an utterance, and a reference (e.g., a pointer to a component that can handle the fulfillment) to a fulfillment for the intent. In other examples, the intent information 124 can include representations of multiple intents. For example, a file including the intent information 124 can be according to a Java Script Object Notation (JSON) format, an Extensible Markup Language (XML) format, and so forth. When adding new intents to the intent repository 108, the user or other source that is adding the intents can ensure that resources that are to be used for fulfilling the intents are available. Such resources can include services, endpoint devices, and so forth. An “endpoint device” can refer to a device that is used to perform a fulfillment action.

In the example of FIG. 1, it is assumed that the intent information 124 includes representations of intents for a new domain. Based on the received intent information 124, the intent importation logic 126 of the intent manager 104 can import new intents 128 (which can include intent H and intent I, for example) for a new domain into the intent repository 108. The format of the intents imported into the intent repository 108 can be based on the type of chatbot 102 used (or the format of the intents can be different from the format used by the type of chatbot 102). For example, the imported intents can be in the format for Amazon LEX, if the chatbot 102 uses the Amazon LEX service. In other examples, the format of the new intents 128 can be according to Google DIALOGFLOW. Microsoft LUIS, and so forth.

In some examples, the intent manager 104 can include an intent format converter 130, which can be in the form of a web service, an application program, or any other type of machine-readable instructions executable by the intent manager 104. The intent format converter 130 can convert from a first format to a different second format. The second format may be the format used by the chatbot 102, whereas the first format may be a format that is different from the second format. In some examples, as part of the validation performed by the intent importation logic 126, the intent importation logic 126 can determine that the format of the intents to be imported is not known or not supported. In such a case, the intent format converter 130 would not be activated, and an indication may be provided to the source indicating that the format of the intents to be added is not known or is not supported.

If the chatbot 102 expects intents in the Amazon LEX format, and the intent information 124 received by the intent manager is in a different format (e.g., Google DIALOGFLOW, Microsoft LUIS, etc.), then the intent manager 104 can invoke the intent format converter 130 to convert the first format of the intents in the intent information 124 into the format expected by the chatbot 102. The new intents 128 imported by the intent manager 104 into the intent repository 108 can be the format produced by the conversion performed by the intent format converter 130.

More generally, the intent manager 104 is able to add new intents to the intent repository 108 in a format expected by the chatbot 102.

The importation of the new intents 128 into the intent repository 108 can be accomplished either manually or based on natural language input that relies on use of a chatbot (e.g., the chatbot 102 or another chatbot) to produce the intents to add to the intent repository 108.

In the manual process, a user of the source device 106 can create or select a file (or multiple files) that include(s) information pertaining to the new intents to be added to the intent repository 108.

Chatbot-Based Creation of New Intents

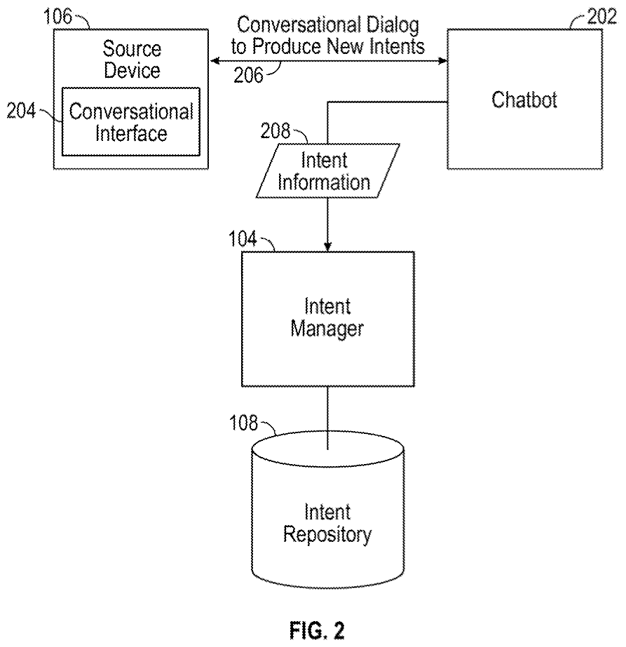

FIG. 2 shows an example where a user at the source device 106 is able to interact with a chatbot 202 for producing new intents to import into the intent repository 108. The chatbot 202 can be the chatbot 102 of FIG. 1 or a different chatbot.

The source device 106 in FIG. 2 includes a conversational interface 204, which allows the user to establish a dialog 206 with the chatbot 202 to exchange information that allows the chatbot 202 to produce the new intents. In such examples, the chatbot 202 is able to understand utterances relating to the intent of creating new intents.

The conversational interface 204 can include audio input device (e.g., a microphone) and an audio output device (e.g., a speaker). The conversational interface 204 can also include a text input device (e.g., a keyboard or touchscreen display) and a display device.

The dialog 206 between the conversational interface 204 and the chatbot 202 can include utterances provided by a user relating to new intents, and responses and queries from the chatbot 202 seeking further information regarding the new intents. For example, the chatbot 202 can ask the user to provide sample utterances for each new intent, as well as metadata for the new intent. Examples of metadata for a new intent are discussed further below.

The fulfillment performed by the chatbot 202 based on the dialog 206 between the user of the source device 106 and the chatbot 202 includes the creation of intent information 208 that includes information of new intent(s) to be imported to the intent repository 108.

The chatbot 202 can communicate the intent information 208 to the intent manager 104, or alternatively, the chatbot 202 can provide the intent information 208 to the source device 106, which can then communicate the intent information 208 to the intent manager 104.

Intent Metadata or Settings

The new intents 128 that are imported into the intent repository 108 can be associated with various metadata (also referred to as “settings” of the intents), including any or some combination of the following: the name of an intent, a description of the intent, a name of an owner of the intent, contact information for the intent (in case a user has to contact the intent owner to ask questions about the intent or in case the chatbot wants to contact the intent owner to provide usage statistics or other information), or tags for the intent. The tags can include words that relate to topics that identify the intent. In further examples, the metadata associated with an intent can include additional or alternative metadata.

Note that some of the metadata can be input by the user or obtained from another source, while other metadata may be inferred automatically based on metadata input by the user or another source.

Intent Validation

During the process of importing a new intent, the intent manager 104 or another entity can perform a validation process of the new intent. For example, the validation process can include checking the intent repository 108 for duplicate or conflicting intents. The validation of the new intent can be performed either before or after addition of the new intent to the intent repository 108.

For the new intent, the validation process can search the intent repository 108 to determine if the new intent already exists in the intent repository 108, or another existing intent in the intent repository 108 is similar to the new intent (based on a comparison of the metadata of the new intent with the metadata of the existing intent and application of a similarity algorithm to determine the similarity of the new intent and the existing intent). In further examples, the set of utterances of the new intent and the set of utterances of an existing intent can be compared to determine similarity of the new intent and the existing intent.

If the new intent matches an existing intent, then the addition of the new intent to the intent repository 108 will fail, and the source that requested the addition of the new intent can be notified, such as by the intent manager 104 or a different entity. If the new intent is similar to the existing intent to within a specified similarity threshold (but the new intent is not identical to the existing intent), then the new intent is considered to conflict with the existing intent. In this case, the existing intent can be modified based on the information of the new intent. For example, the existing intent can include a first collection of utterances each having respective slot(s), the new intent may include a different collection of utterances (e.g., a larger collection, a smaller collection, or an intersecting collection), in which case the validation process can update the existing intent to add new utterances or remove existing utterances. In some examples, the validation process can first seek confirmation from the source requesting the addition of the new intent before making the modification of the existing intent. The interaction with the source can provide guidance regarding the changes (if any) to make to the existing intent.

In some cases, the validation process can identify errors when the new intent is being parsed. The errors may be due to an incorrect syntax of the new intent, or due to the new intent being in a format not supported by the chatbot 102 or 202. In such examples, the validation process can automatically fix the errors (e.g., by fixing the syntax of the new intent, or by converting the new intent to a different format if the validation process determines that the format of the new intent is not supported by the chatbot 102). In some examples, the validation process can first notify the source of the new intent before correcting any errors. In other examples, the validation process can reject the new intent if errors are detected.

Searching the Intent Repository

Users can perform searches of the intent repository 108, such as by using the user devices 112 of FIG. 1. For example, the users can ask the chatbot 102 questions regarding what the chatbot 102 knows. For example, users can ask the chatbot 102 if the chatbot 102 understands intents in a specific domain. In response to such queries, the chatbot 102 can access the intent repository 108 to determine if the intent repository 108 contains intents in the specific domain. In some cases, the chatbot 102 may share with a user a few sample utterances that the user can use to engage a conversation on the requested topic. In other examples, the chatbot 102 may share other intents that the chatbot 102 has knowledge about (e.g., based on determined relationships between intents as discussed above).

In further examples, users can also use the chatbot 102 find sources of intents (e.g., users who created or added the intents). The intent repository 108 can store metadata identifying sources of the intents, as well as contact information of the sources. In response to a query from a user for the source of a specific intent or specific domain of intents, the chatbot 102 can search the intent repository 108 to find the identities and contact information of the sources, and can provide the identities and contact information in responses to the querying user.

### Example Implementations

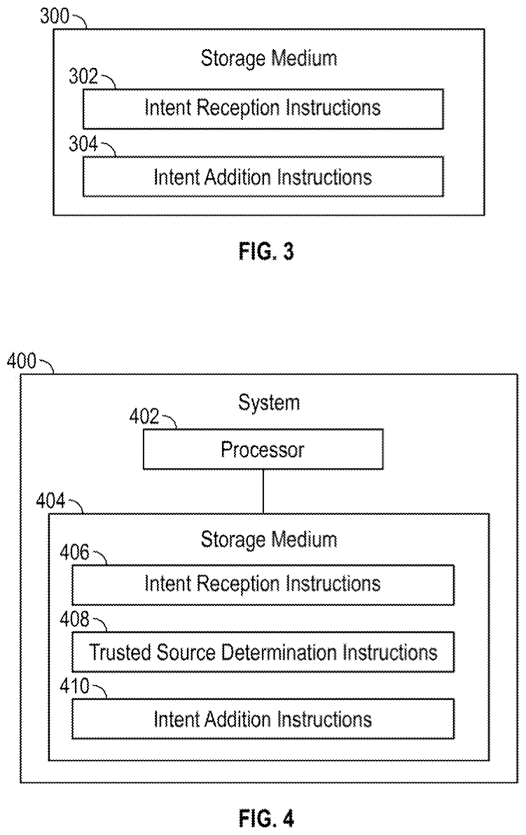

FIG. 3 is a block diagram of a non-transitory machine-readable or computer-readable storage medium 300 storing machine-readable instructions that upon execution cause a system (e.g., the intent manager 104 or another system) to perform various tasks.

The machine-readable instructions include intent reception instructions 302 to receive, from a source associated with a first domain, a first intent for the first domain, the first intent not included in a collection of intents for which a chatbot is able to fulfill requests, the collection of intents comprising a second intent for a second domain different from the first domain.

The machine-readable instructions further include intent addition instructions 304 to add the first intent to an intent repository containing the collection of intents, the intent repository accessible by the chatbot in fulfilling requests corresponding to intents contained in the intent repository, where after the adding of the first intent, the intent repository comprises the first intent for the first domain and the second intent for the second domain.

In further examples, the machine-readable instructions can associate a first indicator with the first intent in response to the source of the first intent being a trusted source, and associate a different second indicator with the first intent in response to the source of the first intent being a trusted source.

In further examples, the machine-readable instructions can convert the first intent from a first format to a second format, the second format recognizable by the chatbot, and the first format being for a different type of chatbot, where the adding of the first intent to the intent repository includes adding the first intent that has been converted to the second format.

In further examples, the machine-readable instructions can, as part of the adding of the first intent to the intent repository, verify that a format of the first intent is supported by the chatbot.

In further examples, the machine-readable instructions can, as part of the adding of the first intent to the intent repository, check that the first intent is not duplicative of or does not conflict with another intent in the intent repository.

In further examples, the machine-readable instructions can receive a search request for information in the intent repository, and in response to the search request, produce output information relating to an intent in the intent repository.

FIG. 4 is a block diagram of a system 400 according to some examples. The system 400 can include a computer or multiple computers. The system 400 includes a hardware processor 402 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 400 further includes a non-transitory storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions include intent reception instructions 406 to receive, from a first source associated with a first domain, a first intent for the first domain, the first intent not included in a collection of intents for which a chatbot is able to fulfill requests, the collection of intents including a second intent for a second domain different from the first domain.

The machine-readable instructions include trusted source determination instructions 408 to determine that the first source is designated as a trusted source of intents for the first domain.

The machine-readable instructions include intent addition instructions 410 to, in response to the determining, add the first intent to an intent repository containing the collection of intents, the intent repository accessible by the chatbot in fulfilling requests corresponding to intents contained in the intent repository, where after the adding of the first intent, the intent repository comprises the intents for a plurality of different domains including the first domain and the second domain.

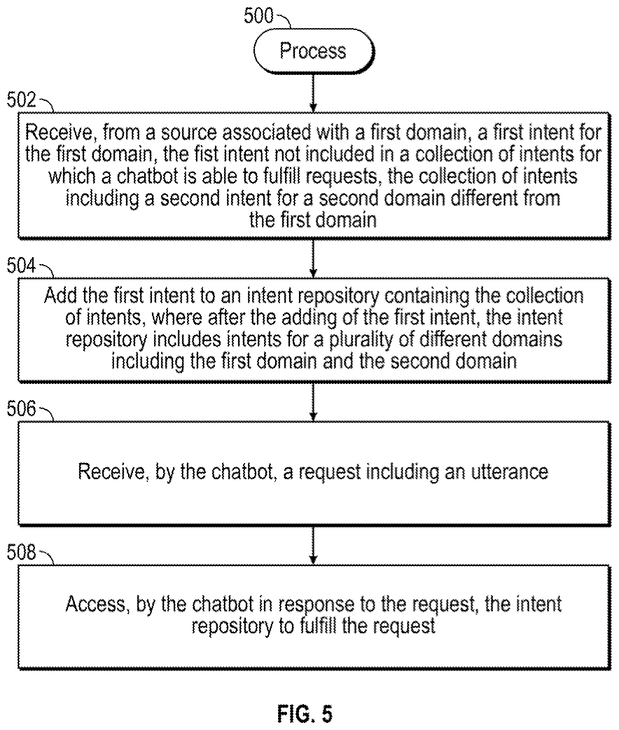

FIG. 5 is a flow diagram of a process 500 according to some examples. The process 500 includes receiving (at 502), from a source associated with a first domain, a first intent for the first domain, the first intent not included in a collection of intents for which a chatbot is able to fulfill requests, the collection of intents including a second intent for a second domain different from the first domain.

The process 500 includes adding (at 504) the first intent to an intent repository containing the collection of intents, where after the adding of the first intent, the intent repository includes intents for a plurality of different domains including the first domain and the second domain.

The process 500 includes receiving (at 506), by the chatbot, a request including an utterance.

The process 500 includes accessing (at 508), by the chatbot in response to the request, the intent repository to fulfill the request.

The storage medium 300 of FIG. 3 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive, from a source associated with a first domain, a first intent for the first domain, the first intent not included in a collection of intents for which a chatbot is able to fulfill requests, the collection of intents comprising a second intent for a second domain different from the first domain; and
add the first intent to an intent repository containing the collection of intents, the intent repository accessible by the chatbot in fulfilling requests corresponding to intents contained in the intent repository, wherein after the adding of the first intent, the intent repository comprises the first intent for the first domain and the second intent for the second domain.

2. The non-transitory machine-readable storage medium of claim 1, wherein the chatbot is useable within an enterprise, and the source is part of the enterprise.

3. The non-transitory machine-readable storage medium of claim 2, wherein the instructions upon execution cause the system to:
disallow an addition of an intent to the intent repository from a source outside the enterprise.

4. The non-transitory machine-readable storage medium of claim 1, wherein the instructions upon execution cause the system to:
allow addition of the first intent to the intent repository in response to confirming that the source is a trusted source.

5. The non-transitory machine-readable storage medium of claim 1, wherein the instructions upon execution cause the system to:
associate a first indicator with the first intent in response to the source of the first intent being a trusted source; and
associate a different second indicator with the first intent in response to the source of the first intent being the trusted source.

6. The non-transitory machine-readable storage medium of claim 1, wherein the instructions upon execution cause the system to:
convert the first intent from a first format to a second format, the second format recognizable by the chatbot, and the first format being for a different type of chatbot,
wherein the adding of the first intent to the intent repository comprises adding the first intent that has been converted to the second format.

7. The non-transitory machine-readable storage medium of claim 1, wherein the instructions upon execution cause the system to:
receive the first intent generated by the chatbot based on an interaction of a user through a conversational interface to the chatbot.

8. The non-transitory machine-readable storage medium of claim 1, wherein the receiving of the first intent comprises receiving metadata for the first intent.

9. The non-transitory machine-readable storage medium of claim 1, wherein the instructions upon execution cause the system to:
as part of the adding of the first intent to the intent repository, verify that a format of the first intent is supported by the chatbot.

10. The non-transitory machine-readable storage medium of claim 1, wherein the instructions upon execution cause the system to:
as part of the adding of the first intent to the intent repository, check that the first intent is not duplicative of or does not conflict with another intent in the intent repository.

11. The non-transitory machine-readable storage medium of claim 1, wherein the instructions upon execution cause the system to:
receive a search request for information in the intent repository; and
in response to the search request, produce output information relating to an intent in the intent repository.

12. A system comprising:
a processor; and
a non-transitory storage medium storing instructions executable on the processor to:
receive, from a first source associated with a first domain, a first intent for the first domain, the first intent not included in a collection of intents for which a chatbot is able to fulfill requests, the collection of intents comprising a second intent for a second domain different from the first domain;
determine that the first source is designated as a trusted source of intents for the first domain; and
in response to the determining, add the first intent to an intent repository containing the collection of intents, the intent repository accessible by the chatbot in fulfilling requests corresponding to intents contained in the intent repository, wherein after the adding of the first intent, the intent repository comprises intents for a plurality of different domains including the first domain and the second domain.

13. The system of claim 12, wherein the instructions are executable on the processor to:
receive, from a second source associated with the second domain, a further intent for the second domain, the further intent not included in the collection of intents;
determine that the second source is a non-trusted source of intents for the second domain; and
in response to the determining that the second source is the non-trusted source, add the further intent to the intent repository, and associating an indicator with the further intent added to the intent repository, the indicator indicating that the further intent is from the non-trusted source.

14. A method performed by a system comprising a hardware processor, comprising:
receiving, from a source associated with a first domain, a first intent for the first domain, the first intent not included in a collection of intents for which a chatbot is able to fulfill requests, the collection of intents comprising a second intent for a second domain different from the first domain;
adding the first intent to an intent repository containing the collection of intents, wherein after the adding of the first intent, the intent repository comprises intents for a plurality of different domains including the first domain and the second domain; and
receiving, by the chatbot, a request comprising an utterance;
in response to the request, accessing, by the chatbot, the intent repository to fulfill the request.

15. The method of claim 14, further comprising:
determining that the source is designated as a trusted source of intents for the first domain,
wherein the adding of the first intent to the intent repository is in response to the determining.
